(19) United States
(12) Patent Application Publication
(10) Pub. No.: US 2023/0252326 A1
(43) Pub. Date: Aug. 10, 2023

(54) SYSTEMS AND METHODS FOR AGENT-BASED ERROR RESOLUTION IN PRIVATE CLOUD APPLICATION USING REINFORCEMENT LEARNING AND CHAOS EXPERIMENTS

(71) Applicant: JPMORGAN CHASE BANK, N.A., New York, NY (US)

(72) Inventors: Bryan ZAKE, Reynoldsburg, OH (US); Pihu SHARMA, Metuchen, NJ (US); Taylor Haoyu XU, London (GB); Aparajita RANA, Monroe Township, NJ (US); Alexandra LACHMANN, New York, NY (US)

(21) Appl. No.: 18/164,179

(22) Filed: Feb. 3, 2023

Related U.S. Application Data
(60) Provisional application No. 63/267,560, filed on Feb. 4, 2022.

(51) Int. Cl. G06N 5/043; G06N 5/022

(52) U.S. Cl. CPC G06N 5/043; G06N 5/022

(57) ABSTRACT

Systems and methods for agent-based error resolution in private cloud application using reinforcement learning and chaos experiments are disclosed. In one embodiment, a method for training an agent computer program using reinforcement learning and chaos experiments may include: (1) causing, by an agent management computer program, a failure in a simulated environment that the agent computer program is deployed, wherein the agent computer program is configured to implement an action in response to the failure; (2) detecting, by the agent management computer program, an impact of the action in the simulated environment; and (3) rewarding, by the agent management computer program, the agent computer program in response to the impact of the action being a positive impact.

### RELATED APPLICATIONS

This application claims priority to, and the benefit of, U.S. Provisional Patent Application Ser. No. 63/267,560, filed Feb. 4, 2022, the disclosure of which is hereby incorporated, by reference, in its entirety.

### BACKGROUND OF THE INVENTION

### 1. Field of the Invention

Embodiments generally relate to systems and methods for agent-based error resolution in private cloud application using reinforcement learning and chaos experiments.

### 2. Description of the Related Art

Software applications in cloud environments can be costly to maintain, even if those applications are modern applications. Things can—and do—go wrong, and bugs can be present despite engineers' best efforts. Software applications may be resilient to failures, but there is no consistent way to prove this without testing or having a failure event occur. When a resiliency event happens, applications and teams may not always be equipped to respond quickly enough to prevent business impact.

Chaos engineering is a valuable tool for Site Reliability Engineers to test how resilient their applications happen to be. In Chaos engineering, failure events are injected into applications and their environments to test how well they handle those failure events. Chaos experiments are typically designed and created to test production applications abilities to handle failures when they occur. Typically, it is expected that the application will stay in a healthy enough state such that it still performs its primary functions. This, however, is not always the case, which is why chaos experiments are performed. Failures from the chaos experiments give engineers time to identify and fix causes of the failures. In a real production failure scenario, resiliency features typically exist to prevent total application outage, giving engineers enough time to determine what went wrong and fix the issue that degraded the application, so that the application can return to a healthy state.

Chaos engineering usually only addresses classes of failures that are known in advance to the engineers designing the test. If a class of failures is not known, there may be an unknown issue that degrades the application or worse, takes it offline.

Detection and recovery from failures in software applications is often reliant on architectural features of the software application or something innate to the way that the software application was programmed, that accounts for faults or detects faults and recovers from them using a simple fault detection mechanism. When those do not succeed, an engineer will typically have to go and troubleshoot that failure mode, which can result in loss of service availability. Engineers usually have a broad range of tools that they use and access to information to troubleshoot the item that has failed. Computational systems are not typically capable of using those tools due to the complexity of using those tools.

### SUMMARY OF THE INVENTION

Systems and methods for agent-based error resolution in private cloud application using reinforcement learning and chaos experiments are disclosed. In one embodiment, a method for training an agent computer program using reinforcement learning and chaos experiments may include: (1) causing, by an agent management computer program, a failure in a simulated environment that the agent computer program is deployed, wherein the agent computer program is configured to implement an action in response to the failure; (2) detecting, by the agent management computer program, an impact of the action in the simulated environment; and (3) rewarding, by the agent management computer program, the agent computer program in response to the impact of the action being a positive impact.

In one embodiment, the method may also include selecting, by the agent management computer program, the failure based on historical failure data.

In one embodiment, the failure may be caused in the simulated environment by introducing a log file for the failure to the simulated environment.

In one embodiment, the method may also include penalizing, by the agent management computer program, the agent computer program in response to the impact being a negative impact.

In one embodiment, the action may include stopping or restarting an application task.

In one embodiment, the method may also include deploying by the agent management computer program, the agent computer program to a production environment; testing, by the agent management computer program, the agent computer program in the production environment; and deploying by the agent management computer program, the agent computer program to run autonomously in the production environment in response to the agent computer program passing the testing.

In one embodiment, the testing may include testing the agent computer program with a plurality of faults in the production environment.

According to another embodiment, a method for training an agent computer program using reinforcement learning and chaos experiments may include: (1) detecting, by the agent computer program, a negative change in a simulated environment in which the agent computer program is deployed, wherein the negative change is caused by a failure introduced by an agent management computer program; (2) selecting, by the agent computer program, an action in response to the negative change; (3) executing, by the agent computer program, the action; (4) receiving, by the agent computer program and from the agent computer program, a reward in response to an impact of the action being a positive impact; and (5) updating, by the agent computer program, a score for the action based on the reward.

In one embodiment, the failure may be selected based on historical failure data.

In one embodiment, the action may be selected from a plurality of actions, and the action that is selected has a highest score.

In one embodiment, the action may include stopping or restarting an application task.

In one embodiment, the method may also include receiving, by the agent computer program, a penalty from the agent computer program, a penalty in response to the impact being a negative impact, and updating, by the agent computer program, the score for the action based on the penalty.

In one embodiment, the method may also include detecting, by the agent computer program, the negative change in the simulated environment by detecting a status of one or more tasks in the simulated environment and communicating the status to the agent management computer program.

In one embodiment, the agent computer program may be deployed to a production environment by the agent management computer program and may run autonomously.

According to another embodiment, a system may include an electronic device executing an agent management computer program that manages training and deployment of an agent computer program and a simulated environment. The agent management computer program deploys the agent computer program to the simulated environment, the agent management computer program causes a failure in a simulated environment, the agent computer program detects a negative change in the simulated environment, the agent computer program selects an action in response to the negative change, the agent computer program executes the action, the agent management computer program detects an impact of the action, the agent management computer program rewards the agent computer program in response to the impact of the action being a positive impact, and the agent computer program updates a score for the action based on the reward.

In one embodiment, the agent management computer program may select the failure based on historical failure data.

In one embodiment, the agent management computer program may penalize the agent computer program in response to the impact being a negative impact, and the agent computer program updates the score for the action based on the penalty.

In one embodiment, the action may include stopping or restarting an application task.

In one embodiment, the agent computer program may detect the negative change in the simulated environment by detecting a status of one or more tasks in the simulated environment and communicating the status to the agent management computer program.

In one embodiment, the system may also include a production environment, and the agent management computer program deploys the agent computer program to the production environment, tests the agent computer program in the production environment, and deploys the agent management computer program to run autonomously in the production environment in response to the agent computer program passing the testing.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for agent-based error resolution in private cloud application using reinforcement learning and chaos experiments according to an embodiment;

FIG. 2 illustrates a method for training an agent using reinforcement learning and chaos experiments according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for agent-based error resolution in private cloud application using reinforcement learning and chaos experiments.

Embodiments provide computational systems with access to tools and information so that the computational systems can learn how to resolve errors that would otherwise require an engineer to fix.

Using an action API, a set of actions that are specific to an application that an agent can perform in an environment may be defined. The actions may be any suitable action, such as creating storage volumes on storage hardware, deleting storage volumes, modifying metadata of a storage account, adjusting a parameter in application metadata, restarting an application task, stopping an application task, etc. These actions are available to a reinforcement learning agent during training, testing, and when in a production environment. The actions are an expandable list, that can be added to the repertoire of the agent by retraining on those actions after they have been added to the action API.

In addition, the agent may read from a state API, or an API that provides a comprehensive set of information about the environment that it is managing, in order to train and react appropriately with proper actions during training, testing, and when it is in a real production environment.

During training and testing, a series of randomly generated chaos experiments are created. These are controlled trials that fail a portion of the application that the agent is being trained to manage. Any piece of the application may be failed during the random trial, it is the role of the agent to learn, through reinforcement learning, what actions to perform to recover from the failure via the abilities provided to it from the action API and the information provided by the environment state API.

During training, the agent acts in a simulated environment that matches a real environment. During this time, the generated failures correspond to a failure state space that the agent may see in a real environment. The agent is then able to read from a simulated state API and perform actions through a simulated action API.

Once the agent is trained, the agent may be tested in a real environment using a series of chaos experiments that cause a similar class of randomized failures to what the agent experienced during training.

When a new failure mode is discovered, the agent can be retrained to resolve that error type when it runs across it in simulation. Additionally, the space of failure modes can be searched for new classes of possible failures to create additional chaos experiments from which the agent can be retrained on. If the agent encounters a new error that it has seen in another application, it will take the best-known set of actions in order to see if it can resolve the error and return the application to a healthy state. The agent may be enabled to continuously update its expected reward based on new errors encountered and methods of solving them.

In embodiments, a new agent may be created that handles a subset of resolutions to a particular problem.

In embodiments, the agent may not be given explicit instructions as to how to handle a specific error. A reinforcement learning algorithm or a deep reinforcement learning algorithm may be used to train the agent to find the optimal actions that result in the highest rewards, which are those that bring the application back to the most desirable state, which is one that is not resulting in errors.

Embodiments may provide at least some of the following advantages:
Provides error detection relevant to internal systems;
Agent trains on errors generated from data that the application produces;
Agent learns from a set of custom actions to resolve those errors;
Agent is able to learn new solution sets on new errors without humans encoding instructions on how to solve the error; and
Reduces human interaction in APIs to resolve issues.

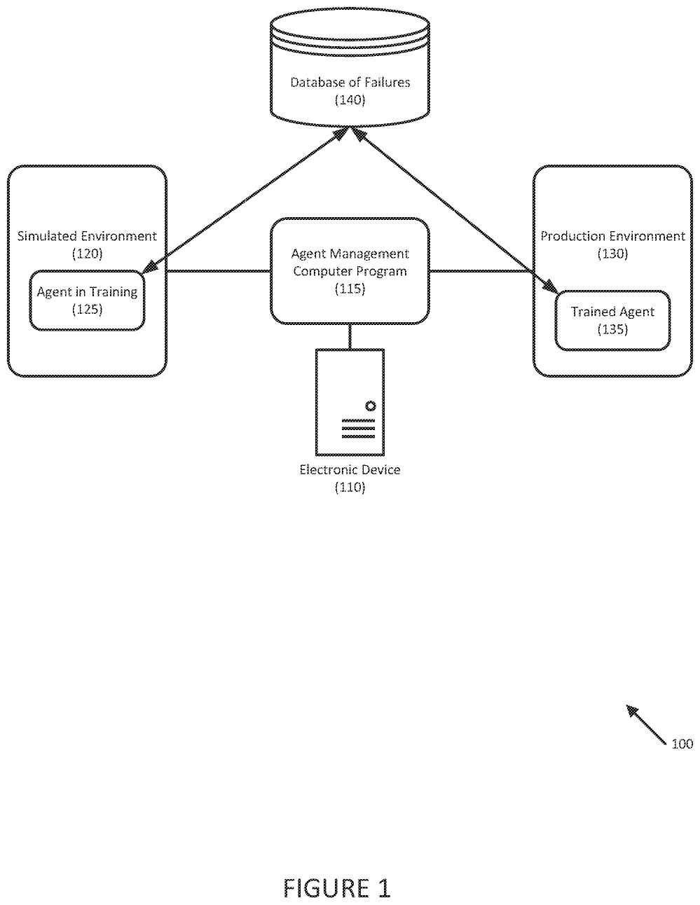

Referring to FIG. 1, a system for agent-based error resolution in private cloud application using reinforcement learning and chaos experiments is disclosed according to an embodiment. System 100 may include electronic device 110, which may be a server (e.g., physical and/or cloud-based server), a computer (e.g., workstation, desktop, notebook, laptop, etc.), Internet of Things (“IoT”) appliance, etc. Electronic device 110 may execute agent management computer program 115, which may manage the training of one or more software agents 125 in simulated environment 120. Once trained, agent management computer program 115 may deploy trained agent 135 to production environment 130 wherein it may be tested. If testing is successful, trained agent 135 may remain in production environment 130; if testing is unsuccessful, trained agent may be trained in simulated environment. For example, simulated environment 120 and/or production environment 130 may be cloud environments.

System 100 may further include database 140 which may include different failures or faults. It may also include historical log files so that agent management computer program 115 can monitor simulated environment 120 and/or production environment 130 to see if an action that is taken resulted in a positive change.

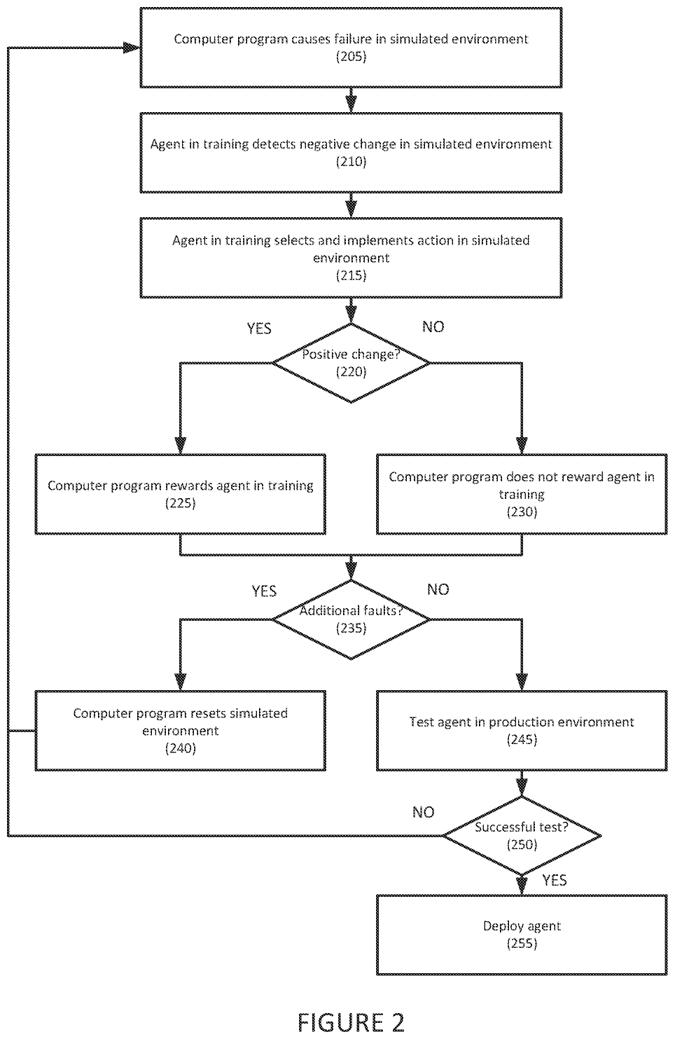

Referring to FIG. 2, a method for training an agent using reinforcement learning and chaos experiments is disclosed according to an embodiment.

In step 205, a computer program, such as an agent management computer program, may cause a failure or fault in a simulated environment in which an agent in training is monitoring. In one embodiment, the agent in training may operate in the simulated environment.

In one embodiment, the failure or fault may be selected based on, for example, historical data. For example, failures or faults that are routinely encountered may be identified and selected. The failure or fault may be introduced to the simulated environment as one or more assorted log files.

In step 210, the computer program may detect a negative change in the simulated environment. For example, an agent in training in the simulated environment may detect a status of one or more tasks and may communicate, via an API (e.g., an environment status API), the status to the computer program. If the status indicates an error, a negative change is detected. The status may also include a task identifier, the task status, etc.

In step 215, the agent in training may select and implement an action in the simulated environment. For example, the agent in training may maintain a library of historical actions and results of those actions. Each action in the library may start with the same score, and as the agent in training learns, different actions and success rates will result in different scores. The agent in training may identify and select the action with the highest score for the environment.

In one embodiment, the agent in training may implement the action in the simulated environment using, for example, an action API.

Example actions may include creating storage volumes on storage hardware, deleting storage volumes, modifying metadata of a storage account, adjusting a parameter in application metadata, restarting an application task, stopping an application task, etc. Any other suitable action may be used as is necessary and/or desired.

In step 220, the computer program may monitor the simulated environment for the impact of the action. If the action results in a positive change, in step 225, the computer program may reward the agent in training. If the change is not a positive change (e.g., it is a negative change), in step 230, the computer program may not reward the agent in training, or it may penalize the agent in training

In one embodiment, if there is no change in the simulated environment, the computer program may not reward the agent in training, or it may penalize the agent in training.

The agent in training may update a score or weighting for the selected action in response to the reward or penalty. For example, the score may be increased in response to a reward, and decreased or unchanged in response to a penalty.

If, in step 235, there are additional faults to train, in step 240, the computer program may reset the simulated environment and the process may return to step 205. For example, different faults may be tested, and the computer program may continue to test additional faults until the simulated environment is detected as positive.

If training is complete, in step 245, the computer program may test the agent in a production environment. The testing may be similar to the testing performed in the simulated environment.

In step 250, if the agent passes the test(s), in step 255, the agent may be deployed to run autonomously. If the agent does not pass the test, the process may return to step 205.

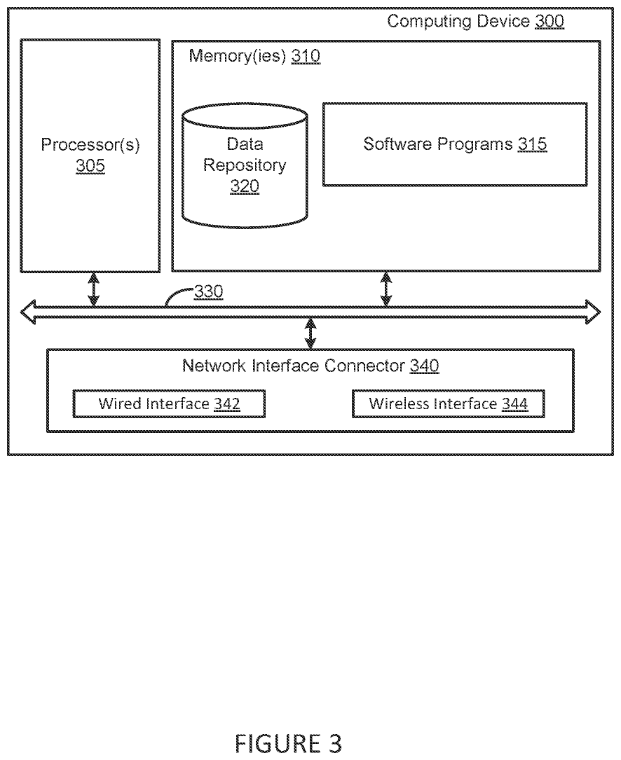

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for training an agent computer program using reinforcement learning and chaos experiments, comprising:
causing, by an agent management computer program, a failure in a simulated environment that the agent computer program is deployed, wherein the agent computer program is configured to implement an action in response to the failure;
detecting, by the agent management computer program, an impact of the action in the simulated environment; and
rewarding, by the agent management computer program, the agent computer program in response to the impact of the action being a positive impact.

2. The method of claim 1, further comprising:
selecting, by the agent management computer program, the failure based on historical failure data.

3. The method of claim 1, wherein the failure is caused in the simulated environment by introducing a log file for the failure to the simulated environment.

4. The method of claim 1, further comprising:
penalizing, by the agent management computer program, the agent computer program in response to the impact being a negative impact.

5. The method of claim 1, wherein the action comprises stopping or restarting an application task.

6. The method of claim 1, further comprising:
deploying by the agent management computer program, the agent computer program to a production environment;
testing, by the agent management computer program, the agent computer program in the production environment; and
deploying by the agent management computer program, the agent computer program to run autonomously in the production environment in response to the agent computer program passing the testing.

7. The method of claim 6, wherein the testing comprises testing the agent computer program with a plurality of faults in the production environment.

8. A method for training an agent computer program using reinforcement learning and chaos experiments, comprising:
detecting, by the agent computer program, a negative change in a simulated environment in which the agent computer program is deployed, wherein the negative change is caused by a failure introduced by an agent management computer program;
selecting, by the agent computer program, an action in response to the negative change;
executing, by the agent computer program, the action;
receiving, by the agent computer program and from the agent computer program, a reward in response to an impact of the action being a positive impact; and
updating, by the agent computer program, a score for the action based on the reward.

9. The method of claim 8, wherein the failure is selected based on historical failure data.

10. The method of claim 8, wherein the action is selected from a plurality of actions, and the action that is selected has a highest score.

11. The method of claim 8, wherein the action comprises stopping or restarting an application task.

12. The method of claim 8, further comprising:
receiving, by the agent computer program, a penalty from the agent computer program, a penalty in response to the impact being a negative impact; and
updating, by the agent computer program, the score for the action based on the penalty.

13. The method of claim 8, further comprising:
detecting, by the agent computer program, the negative change in the simulated environment by detecting a status of one or more tasks in the simulated environment and communicating the status to the agent management computer program.

14. The method of claim 8, wherein the agent computer program is deployed to a production environment by the agent management computer program and runs autonomously.

15. A system, comprising:
an electronic device executing an agent management computer program that manages training and deployment of an agent computer program; and
a simulated environment;
wherein:
the agent management computer program deploys the agent computer program to the simulated environment;
the agent management computer program causes a failure in a simulated environment;
the agent computer program detects a negative change in the simulated environment;
the agent computer program selects an action in response to the negative change;
the agent computer program executes the action;
the agent management computer program detects an impact of the action;
the agent management computer program rewards the agent computer program in response to the impact of the action being a positive impact; and
the agent computer program updates a score for the action based on the reward.

16. The system of claim 15, wherein the agent management computer program selects the failure based on historical failure data.

17. The system of claim 15, wherein the agent management computer program penalizes the agent computer program in response to the impact being a negative impact, and the agent computer program updates the score for the action based on the penalty.

18. The system of claim 15, wherein the action comprises stopping or restarting an application task.

19. The system of claim 15, wherein the agent computer program detects the negative change in the simulated environment by detecting a status of one or more tasks in the simulated environment and communicating the status to the agent management computer program.

20. The system of claim 15, further comprising a production environment, wherein the agent management computer program deploys the agent computer program to the production environment, tests the agent computer program in the production environment, and deploys the agent management computer program to run autonomously in the production environment in response to the agent computer program passing the testing.
